(19) United States
(12) Patent Application Publication
(10) Pub. No.: US 2016/0112761 A1
(43) Pub. Date: Apr. 21, 2016

(54) SYSTEMS AND METHODS FOR GENERATING MEDIA ASSET RECOMMENDATIONS USING A NEURAL NETWORK GENERATED BASED ON CONSUMPTION INFORMATION

(71) Applicant: United Video Properties, Inc., Santa Clara, CA (US)

(72) Inventors: Sashikumar Venkataraman, Andover, MA (US); Murali Aravamudan, Andover, MA (US); Ahmed Nizam Mohaideen P, Tamilnadu (IN); Craig Carmichael, Lakeville, MN (US)

(21) Appl. No.: 14/518,057

(22) Filed: Oct. 20, 2014

(51) Int. Cl. H04N 21/466; H04N 21/482; H04N 21/25; H04N 21/442

(52) U.S. Cl. CPC H04N 21/4668; H04N 21/4667; H04N 21/44222; H04N 21/4826; H04N 21/252

(57) ABSTRACT

Systems and methods for maintaining a model representing media asset relationships are provided. A combination of media assets consumed by a first user is identified. A first media asset in the combination is associated with a first vector of values and a second media asset in the combination is associated with a second vector of values and a distance between the first vector and the second vector is a first amount. A determination is made as to whether a second user consumed the combination of media assets. In response to determining that the second user consumed the combination of media assets, the values stored in the first and second media asset vectors are adjusted such that the distance between the first media asset vector and the second media asset vector is reduced to a second amount that is less than the first amount.

### BACKGROUND

Traditional systems generate a recommendation for a user based on one of several models. For example, the system may use a collaborative filtering model by which individual media assets viewed by a particular group may influence what is recommended to another group of users. Alternatively, these systems may recommend media assets that share some attributes with previously consumed media assets. Although the recommendations produced by these systems are effective, the models do not take into account other factors that can improve the recommendations.

### SUMMARY

Accordingly, systems and methods for generating media asset recommendations using a neural network generated based on consumption information are provided.

In some embodiments, systems and methods for maintaining a model representing media asset relationships are provided. A combination of media assets that includes first and second media assets consumed by a first user is identified. For example, a viewing history for the first user may be retrieved to identify a group of media assets consumed by the first user. In implementations, the group of media assets consumed by the first user is added to a neural network such that each media asset in the group is linked to each other media asset in the group. In some implementations, the media assets that are fed or added into the neural network are further represented as vectors. In such circumstances, the first media asset in the combination is associated with a first vector of values and the second media asset in the combination is associated with a second vector of values, and a distance between the first vector and the second vector is a first amount. As referred to herein, the term “vector” refers to a collection of values which may be stored as an array of the values where each value in the array corresponds to a different dimension of the vector.

In some embodiments, a determination is made as to whether a second user consumed the combination of media assets. For example, a viewing history for the second user is retrieved and compared to the viewing history of the first user. If at least two media assets (e.g., the first and second media assets) in the viewing history for the second user are in the viewing history for the first user, the determination is made that the second user consumed at least a portion of the combination of media assets consumed by the first user. In some implementations, the determination may be made based on whether at least two media assets consumed by the second user are already linked to each other in the neural network.

In some embodiments, in response to determining that the second user consumed the combination of media assets, the links that join the combination of media assets (e.g., the first and second media assets) in the neural network may be adjusted. For example, the values of the links that join the combination of media assets may be reduced to indicate that the combination of media assets is more strongly related. In some implementations, the vectors corresponding to the combination of media assets (e.g., the first and second media assets) are adjusted such that the distance between the first media asset vector and the second media asset vector is reduced to a second amount that is less than the first amount. In some implementations, the first and second vectors may be adjusted using a gradient descent function on a function that predicts the probability of an output of a neural network from a set of inputs (e.g., a softmax classifier function). As referred to herein, a function that models the relationships between nodes or vectors of a neural network is a function that outputs a prediction of the probability of an output asset (e.g., an output vector or node) from vectors of the input assets or nodes. Although this disclosure is discussed in terms of the softmax classifier function being used to determine a probability of an output given a set of input nodes or vectors of media assets in the neural network, any other function may be used. The function modeling the neural network may receive as input a set of vectors corresponding to media assets in the neural network and may output a classification for these vectors (e.g., a predicted vector when such input vectors are triggered). Accordingly, based on the determination that a second user consumed the same combination of media assets consumed by the first user, the system may store an indication that the media assets in the combination are more closely related.

In some embodiments, to adjust the values of the vectors corresponding to the media assets the first user has consumed, the system may use a gradient descent function on the softmax classifier function. In some implementations, the system may iterate through each combination of vectors corresponding to the media assets consumed by the first user taking a different one of the vectors as the output of the softmax classifier function, at each iteration, and all the other vectors as the input. By applying a first of the vectors of the media asset the first user consumed as the output of the softmax classifier function and the other vectors as the input, the softmax classifier function indicates how close or far the approximation of the other vectors are to the first vector (e.g., an error value). The gradient decent function may then be applied to the first vector in order to adjust the first vector values to make the approximation of the other vectors, when applied as an input to the softmax classifier function, more closer to the first vector. In some implementations, the values of the other vectors may also be adjusted by the gradient decent and/or vectors of other media assets not consumed by the first user. At a next iteration, this process may be repeated taken a second of the vectors of the media asset the first user consumed as the output of the softmax classifier function and the other vectors as the input and then adjusting values stored in the second vector using the gradient decent function.

In some embodiments, the combination of media assets consumed by the first user is identified by retrieving the first and second vectors associated with the first and second media assets consumed by the first user and adjusting values stored in the first and second vectors based on a function (e.g., a stochastic gradient descent function or other gradient descent function) such that the distance between the first and second vectors is the first amount. The determination that the second user consumed the same combination may be performed by identifying a plurality of media assets consumed by the second user, wherein the plurality of media assets includes the first and second media assets. In some implementations, values stored in the vectors are adjusted by applying the function to vectors corresponding to the plurality of media assets consumed by the second user to adjust the vectors corresponding to the plurality of media assets such that the distance between the first and second vectors is reduced to the second amount.

In some implementations, the distance between vectors corresponding to the media assets (e.g., the media assets in the neural network) may be determined based on a dot product between one vector and another. For example, a dot product between the first media asset vector and the second media asset vector may be computed to determine a distance between these two media assets. To increase the strength of the relationship between the media assets in the neural network, the values in the vectors for the media assets may be adjusted (e.g., reduced) such that the dot product becomes closer to a predetermined value (e.g., ‘1’). In some implementations, the distance between the first and second vectors may be indicative of a contextual relationship between the first and second media assets. In some implementations, the relationship strength between vectors corresponding to the media assets (e.g., the media assets in the neural network) may be determined based on a function that models the neural network (e.g., softmax classifier function).

In some embodiments, the distance between the first and second media asset vectors corresponding to the combination consumed by the first and second users may be reduced by a first factor. In some implementations, the amount by which a distance between two media asset vectors is adjusted may be based on a sentimental relationship of a user between the two media assets and/or an absolute sentimental value of the user for at least one of the two media assets. For example, the gradient descent function may consider the sentimental relationship of a user between two media assets and/or an absolute sentimental value of the user for at least two media assets when adjusting values stored in the corresponding vectors. In some embodiments, when media asset vectors are applied to the softmax classifier function to predict the probability of an output vector, the sentimental relationship of a user for the media assets vectors being applied and/or an absolute sentimental value of the user for the vectors may be considered. In some implementations, a plurality of media assets corresponding to an attribute may be identified. Each of the plurality of media assets corresponding to the attribute is associated with a respective vector of values. The values stored in the respective vectors of the plurality of media assets may be adjusted such that a distance between each of the respective vectors is reduced by a second factor.

In some embodiments, a determination is made as to whether the plurality of media assets associated with an attribute includes the first and second media assets consumed by the first and second users. In response to determining that the plurality of media assets includes the first and second media assets, the values stored in the first and second media asset vectors may be adjusted such that the distance between the first media asset vector and the second media asset vector is reduced to a third amount that is less than the second amount. In some implementations, the values of the links joining the first and second media assets in the neural network may be adjusted (e.g., reduced) in response to determining that the plurality of media assets includes the first and second media assets to strengthen the relationship between the first and second media assets. The process of adjusting the values of the vectors corresponding to the media assets associated with the attribute may be the same or similar to that which is applied for media assets a given user consumed (e.g., using a gradient descent function on a function that predicts an output given a set of inputs of the neural network).

In some embodiments, input received from a third user is processed to determine whether text corresponding to the input includes the combination of the first and second media assets. In some implementations, the input from the third user may include at least one of a review, a social network communication, an SMS message, a chat room, and a blog. In response to determining that the combination of the first and second media assets is included in the input, the values stored in the first and second media asset vectors are adjusted such that the distance between the first media asset vector and the second media asset vector is reduced to a third amount that is less than the second amount. In some implementations, the values of the links joining the first and second media assets in the neural network may be adjusted (e.g., reduced) in response to determining that the plurality of media assets includes the first and second media assets to strengthen the relationship between the first and second media assets. The process of adjusting the values of the vectors corresponding to the media assets associated with the input received from the third user may be the same or similar to that which is applied for media assets a given user consumed (e.g., using a gradient descent function on a function that models the relationships among nodes of the neural network).

In some embodiments, a plurality of media assets consumed by a third user is identified. A given media asset may be selected from the plurality of media assets, the given media asset being associated with a third vector of values. A plurality of candidate media assets, not previously consumed by the third user, is identified using the neural network or model. The plurality of candidate media assets may be associated with vectors of values that are within a threshold distance of the third vector of values corresponding to the third media asset. In some implementations, the neural network may be processed to identify the candidate media assets (not previously consumed by the third user) that are joined to the third media asset by links having less than a predetermined value (e.g., indicating that the candidate media assets are related to the third media asset by more than a threshold value). In some embodiments, the system may apply the vectors corresponding to the plurality of media assets consumed by the third user as inputs to the function that models the neural network (e.g., the softmax classifier function) to receive as an output of the function a prediction (classification) of a vector corresponding one or more media assets (e.g., the candidate media assets) in the neural network that has not been consumed by the third user.

In some embodiments, a recommendation may be generated and provided to the third user based on the plurality of candidate media assets and/or based on the vector that is output by the softmax classifier function. In some implementations, the plurality of media assets consumed by the third user includes the first media asset but not the second media asset. In such circumstances, the second media asset may be included in the plurality of candidate media assets and a recommendation of the second media asset may be generated and provided to the third user.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with an embodiment of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIGS. 5-7 show illustrative updates to a neural network of media assets based on user consumption in accordance with some embodiments of the disclosure;

FIGS. 8 and 9 show illustrative updates to a neural network of media assets based on media attributes in accordance with some embodiments of the disclosure; and

FIG. 10 is a diagram of a process for updating a neural network of media assets in accordance with some embodiments of the disclosure.

### DETAILED DESCRIPTION

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, media asset vectors, sentimental relationship vectors, sentiment vectors, neural network models of media assets, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

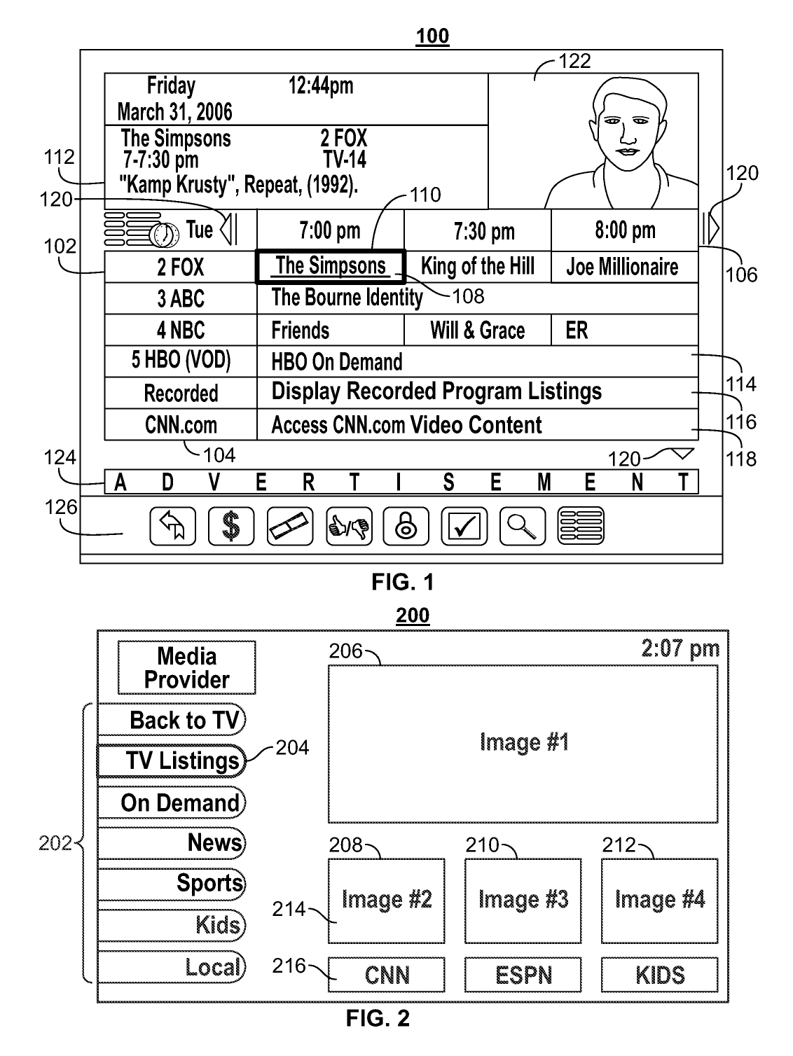

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 1 shows illustrative grid of a program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases. The content identified in advertisement 124 may be selected based on a media asset neural network model (discussed below).

For example, the media guidance application may identify a current user of user equipment device 300. The media guidance application may select a media asset recently consumed by the current user. Using the neural network, the media guidance application may identify another media asset (e.g., a media asset the current user has not previously consumed) that is related to the selected media asset (e.g., a media asset associated with a vector having a shortest distance among other media asset vectors in the neural network to the selected media asset). In some embodiments, the shortest distance may be determined by the media guidance application by first computing a dot product between a multi-dimensional vector of the selected media asset and a multi-dimensional vector of each other media asset in the neural network. In some implementations, a distance between two vectors may be determined using a gradient descent function on a softmax classifier function. Then, the media guidance application may identify the another media asset related to the selected media asset based on which dot product is closest to a predetermined value (e.g., ‘1’). In some implementations, the media guidance application may only identify another media asset that the current user has not previously consumed or a media asset that the current user has not previously consumed in a particular amount of time (e.g., more than 2 weeks). In some implementations, the media guidance application may identify the another media asset by applying the media assets the current user consumed to the neural network. Specifically, the media guidance application may apply as inputs to the softmax classifier function vectors corresponding to media assets the current user consumed to identify an approximate vector of the neural network when such vectors are input. The media guidance application may then identify the corresponding media asset that is most likely associated with the identified approximate vector as the another media asset. The another media asset may then be presented to the current user in the form of advertisement 124.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

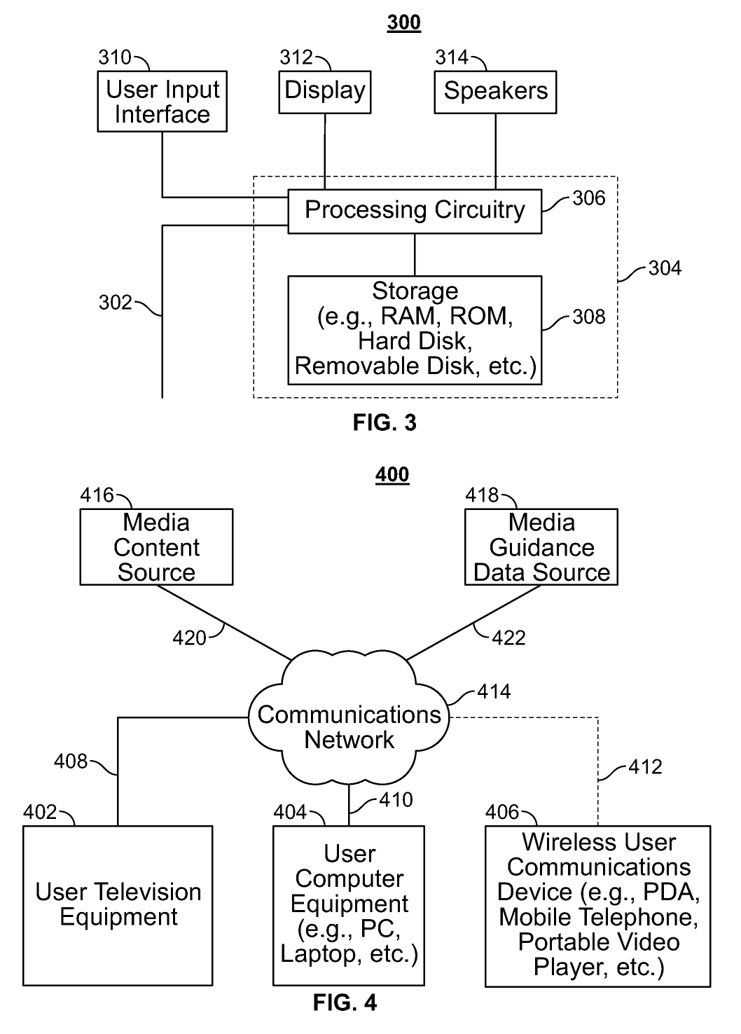

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same.

Storage 308 may be used to store various types of content described herein as well as media guidance data described above. For example, storage 308 may be used to store multi-dimensional vectors associated with each media asset (including sentiment vectors for each user) in a neural network. Storage 308 may be used to store media consumption activity and/or a viewing history (e.g., identifying which media assets have been viewed or consumed by a given user) associated with various users to generate/update the media asset neural network. Nonvolatile memory may also be used (e.g., to launch a boot-up routine and other instructions). Storage 308 may be used to store the function that is used to model the relationship among nodes of the neural network (e.g., the softmax classifier function). Cloud-based storage, described in relation to FIG. 4, may be used to supplement storage 308 or instead of storage 308. In some embodiments, the viewing history stored for each user may include sentiment vectors. The sentiment vectors may represent an affinity of the user for the media asset in the viewing history. For example, the media guidance application may update sentiment vectors for first and second media assets based on activity the user performed related to the first and second media assets. The activity may include percentage of the media asset the user watched (consumed), how many comments on a social network the user made about the media asset, how many other media asset episodes in a series associated with the media asset the user consumed, how often the user access a content source from which the media asset was received by the user for consumption, a rating the user assigned to the media asset, an explicit rating of the media asset, the time the user consumed the media asset, and/or any combination thereof. In some implementations, each dimension of the sentiment vectors represents a different activity. In some implementations, the sentiment vectors are single dimensional vectors representing only one activity. In some embodiments, an affinity of the user for a given media asset may be determined by the media guidance application based on an absolute value computed from the sentiment vector. The media guidance application may compute the absolute value by determining a magnitude of a given sentiment vector. In some embodiments, a high absolute value may indicate a high affinity (e.g., a strong like) for a given media asset whereas a low absolute value may indicate a low affinity (e.g., a strong dislike) for the media asset.

A distance represented by a dot product of the sentiment vectors associated with the first and second media assets may represent how close an affinity of the user is for the first and second media assets. For example, a larger distance may indicate that the affinity of the user differs greatly between the two media assets (e.g., because the user commented several times and watched to completion the first media asset but only watched a part of the second media asset) whereas a smaller distance may indicate that the affinity of the user is similar (e.g., because the user commented several times and watched to completion the first media asset and watched to completion the second media asset even though the user did not post any comments about the second media asset).

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 312 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly-implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, which provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

In some embodiments, the system (e.g., the media guidance application) trains a model to generate a neural network that represents how contextually related media assets are to each other based on their corresponding viewing activity and metadata. In some embodiments, the system first generates the model by analyzing media asset user viewing activity and then modifying the model based on metadata associated with the media assets. Although this disclosure is discussed in terms of “viewing” of media assets, the teachings are similarly applicable to “consumption” of media assets.

As referred to herein, the phrase “neural network” refers to a representation of associations between nodes, where each node is linked to each other node using a weighted link. In some embodiments, the neural network may be represented as a collection of n-dimensional vectors, where each node is represented by one of the vectors. For example, a neural network of media assets may include four nodes, where each node represents a given media asset and each node is connected to each other node by a link. Namely, the neural network of four nodes may include twelve links (e.g., three links originating from each node to each other node). In some implementations, a greater weight assigned to a link indicates a stronger relationship. In some implementations, a lower weight assigned to a link indicates a stronger relationship. For purposes of illustration and not limitation, this disclosure is described in the context of lower weights being representative of stronger relationships between nodes. Relationships between nodes of the neural network may be represented as a function (e.g., a softmax classifier function). In particular, the function modeling the relationships may identify an approximated output (corresponding to a given node of the neural network) given a set of inputs (corresponding to a given set of nodes in the neural network). For example, for a neural network of 4 nodes (A, B, C and D), the function may approximate a value most closely corresponding to node D when nodes B and C are triggered or fired. Accordingly, the function indicates that when B and C are input they are most closely related to node D.

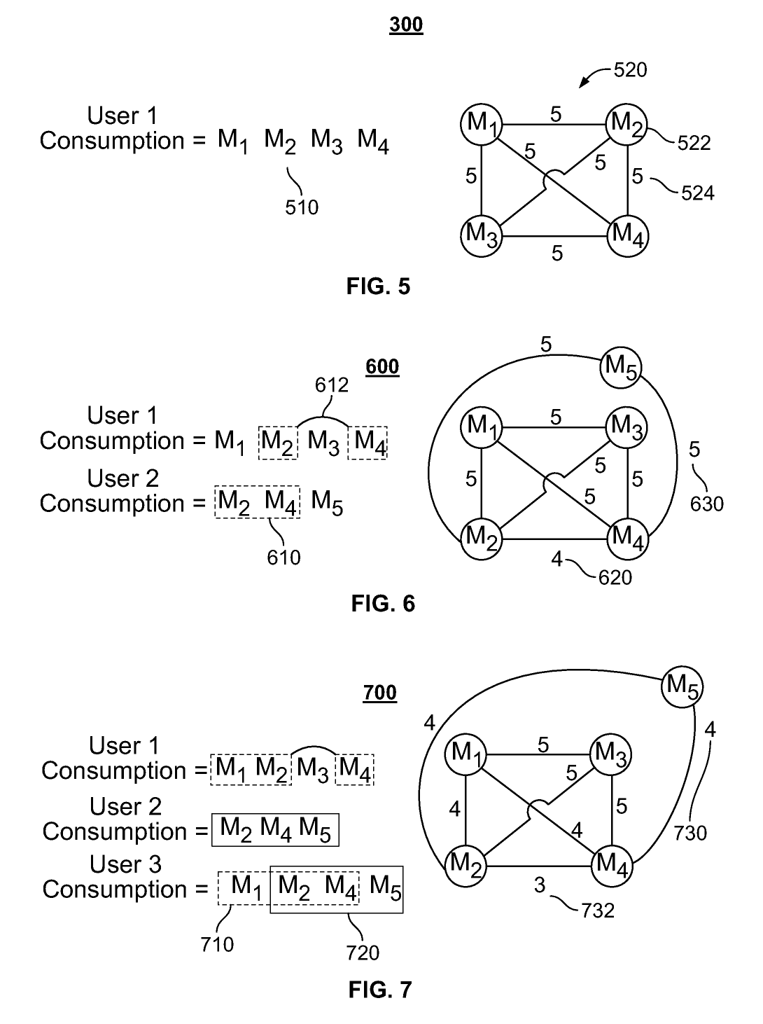

FIGS. 5-7 show illustrative updates to a neural network of media assets 500-700 based on user consumption in accordance with some embodiments of the disclosure. In some embodiments, to generate/update the neural network by analyzing the media asset user viewing activity, the media guidance application may first select a group of users (e.g., all users or a select subset of users of a given system or service provider). For example, the media guidance application may select three users. The media guidance application may identify a first set of media assets that have been viewed or consumed by a first user in the group.

For example, as shown in FIG. 5, the media guidance application may identify media assets 510 (e.g., M₁, M₂, M₃, and M₄) as media assets consumed by the first user. The media guidance application may add each of the identified media assets to a neural network 520 and associate each of these media assets with a first set of equal values 524 (e.g., the value five) that represent how closely related the media assets are to each other. For example, the media guidance application may associate values with each link in the neural network between each of the media assets with the first set of equal values. Alternatively or in addition, the media guidance application may adjust values stored in an n-dimensional vector associated with each of the media assets to make the vectors closer to each other. Specifically, the media guidance application may modify the values stored in the vectors for each of the media assets such that the dot product of the vectors is closer to a predetermined value (e.g., ‘1’) than before being modified.

In some embodiments, the media guidance application may iteratively update the values of the vectors corresponding to media assets 510 using a gradient descent function based on the softmax classifier function. For example, at a first iteration, the media guidance application may apply as inputs to the softmax classifier function all of the vectors corresponding to the media assets in the neural network (e.g., M₂, M₃, M₄, . . . , Mₙ) except a first vector corresponding to a first of media assets 510 (e.g., M₁). Although all of the vectors except the first vector are input to the softmax classifier function, only those vectors that are input corresponding to media assets 510 consumed by the first user are triggered or fired (e.g., only M₂, M₃ and M₄ are triggered or fired). The first vector may be applied as the output of the softmax classifier function. The media guidance application may then use the gradient descent function to adjust the values of the first vector to increase the likelihood that when the input vectors are applied to the softmax classifier function, the first vector is approximated. In some implementations, the gradient descent function may also adjust the values of some or all of the vectors that are input to the softmax classifier function. This results in a distance represented by a dot product between a vector corresponding to one of media assets 510 that is used as an input and the first vector to be reduced (e.g., the relationship strength is increased).

At a second iteration, the media guidance application may apply as inputs to the softmax classifier function all of the vectors corresponding to the media assets in the neural network (e.g., M₁, M₃, M₄, . . . , Mₙ) except a second vector corresponding to a first of media assets 510 (e.g., M₂). Although all of the vectors except the second vector are input to the softmax classifier function, only those vectors that are input corresponding to media assets 510 consumed by the first user are triggered or fired (e.g., only M₁, M₃ and M₄ are triggered or fired). The second vector may be applied as the output of the softmax classifier function. The media guidance application may then use the gradient descent function to adjust the values of the second vector to increase the likelihood that when the input vectors are applied to the softmax classifier function, the second vector is approximated. In some implementations, the gradient descent function may also adjust the values of some or all of the vectors that are input to the softmax classifier function. This results in a distance represented by a dot product between a vector corresponding to one of media assets 510 that is used as an input and the second vector to be reduced (e.g., the relationship strength is increased). The media guidance application may continue these iterations until every vector corresponding to one of media assets 510 consumed by the first user is applied as an output to the softmax classifier function and has its corresponding values adjusted using gradient descent.

In some embodiments, values of the links between media assets in the neural network that the first user has consumed may be adjusted based on sentiment vectors associated with each of the media assets. Specifically, the softmax classifier function and/or adjustment of the values using gradient descent may be based on the sentiment vectors of the first user for each media asset consumed by the first user. In particular, instead of equally adjusting distances between vectors of media assets 510 that the first user has consumed, the distances may differ based on sentiment vectors of the media assets. In particular, a sentimental relationship may be determined between some or all of media assets 510 that the first user has consumed. The media guidance application may determine the sentimental relationship by retrieving from storage 308 sentiment vectors for media assets 510 for the first user and computing a distance between the retrieved sentiment vectors. In some implementations, the distance may be computed using a function of a vector dot product of the sentiment vectors. Namely, a stronger sentimental relationship may be determined when the dot product between the vectors is closer to a predetermined value (e.g., ‘1’) and weaker when the dot product is farther from the predetermined value.

In some embodiments, after determining the sentimental relationship between media assets 510 that the first user has consumed, the distances between the corresponding media asset vectors in the neural network may be adjusted based on the sentimental relationship. This may be performed using the gradient descent function. For example, if the sentimental relationship between media assets M₁ and M₂ is stronger than media assets M₁ and M₃, the distance represented by the dot product of the vectors for media assets M₁ and M₂ may be adjusted such that it is closer than the distance represented by the dot product of the vectors for media assets M₁ and M₃. Specifically, the first user may have a similar affinity for media assets M₁ and M₂ but a dissimilar affinity for media assets M₁ and M₃. Accordingly, the media guidance application may adjust the media asset vectors of M₁, M₂ and M₃ in such a way that the amount by which the distance is adjusted for media assets M₁ and M₂ reflects a stronger relationship than the amount by which the distance is adjusted between media assets M₁ and M₃.

In some embodiments, in addition to or alternative to the sentimental relationship, the absolute values of the sentiment vectors for each media asset may be determined and compared by the media guidance application and used to influence the amount by which the distances of the media asset vectors are adjusted. Specifically, if the absolute values of the sentiment vectors for a given set of media asset are similar and highly valued (e.g., all indicating strong likes or strong dislikes for the corresponding media assets), then the distance represented by dot products of the media asset vectors may be adjusted by a first amount. If the absolute values of the sentiment vectors for a given set of media asset are similar and low valued (e.g., all indicating weak likes or weak dislikes for the corresponding media assets) or dissimilar (e.g., some indicating strong/weak likes and others indicating strong/weak dislikes), then the distance represented by the dot product of the media asset vectors may be adjusted by a second amount that is lower than the first amount.

In some embodiments, the media guidance application may compute the softmax classifier function in accordance with equation 1 below:

$$P ( {M}_{0} = M ) = \frac{{e}^{{\sum }_{i} {V}_{mi} \cdot {V}_{m}}}{{\sum }_{j} {e}^{{\sum }_{i} {V}_{m i} \cdot {V}_{mj}}}$$

where P represents an output vector as an approximate vector when a given set of vectors, i and j are applied as inputs to the function. Specifically, i and j represent all the media asset vectors in the neural network, V is a vector associated with a given media asset M, and M₀ is the output vector of the media asset. Specifically, the media guidance application may apply the function to each vector corresponding to media assets 510 by performing equation 1 multiple times where the input parameter is a different set of vectors, excluding the output vector, corresponding to media assets 510 each time. For example, if there are N vectors in the neural network, a given set M of the N vectors may be selected to reduce a distance between the set of M vectors. The M vectors in the set may be the vectors corresponding to media assets a given user has consumed, media assets corresponding to a given attribute, and/or any other set of vectors that need to have values adjusted to adjust a distance represented by dot products of the vectors. In such circumstances, i and j represent all the media vectors in the selected set of M vectors (excluding M₀) and M₀ is a given vector in the set of M vectors that is currently being used as the approximation of the M vectors to reduce a distance between the M vectors and the M₀.

In some implementations, the media guidance application may retrieve from storage 308 a weight or factor (e.g., alpha₁) to use in adjusting values assigned to links between the media assets in neural network 520 or values stored in the corresponding vectors of the media assets. In some implementations, the function (e.g., equation 1) may take into account the retrieved weight or factor by multiplying any one of the terms of the function by the retrieved weight or factor. Specifically, the media guidance application may retrieve a weight or factor that is associated with updates performed on the neural network based on user media consumption activity. In some embodiments, the media guidance application may retrieve a different weight or factor that is associated with updates performed on the neural network for each different media asset attribute or metadata. In some embodiments, the weight or factor may be adjusted based on the sentiment vectors (e.g., the absolute values of the sentiment vectors and/or a sentimental relationship between two or more sentiment vectors). Specifically, in some implementations, the weight or factor may be changed for each pair of nodes in the neural network for which a distance is being adjusted. For example, the weight or factor may vary based on the absolute values of sentiment vectors and/or sentimental relationships between a pair of media asset vectors when a distance represented by a dot product of the pair of media asset vectors is being adjusted. The amount by which the distance is adjusted may depend on the weight or factor associated with the pair of media asset vectors. Specifically, the gradient descent function, used to adjust the vector values, may base the adjustments on the retrieved weight or factor.

In some embodiments, after retrieving the factor or weight, the media guidance application may add (if not already present) a node 522 to neural network 520 for each media asset consumed by the first user. The media guidance application may then link the added node 522 with each other media asset node in neural network 520 that corresponds to a media asset the first user consumed. The media guidance application may associate the link with a value that is determined based on the retrieved value or factor. If a node for a given media asset is already present in neural network 520, the media guidance application may adjust the value (e.g., reduce the value) of the links for that node that connect that node to each other media asset the first user consumed by the retrieved factor or weight (as adjusted if necessary based on the sentiment vectors). In some implementations, a lower value for a given link may indicate a stronger relationship between the two nodes linked by the given link.

In some embodiments, each media asset may be associated with an n-dimensional vector. In such circumstances, after retrieving the factor or weight, the media guidance application may adjust (e.g., reduce) values stored in each vector of a media asset consumed by the first user by an amount corresponding to the factor or weight. Specifically, the media guidance application may adjust the values stored in a first vector, corresponding to a first media asset the first user has consumed, such that a dot product between the first vector and a second vector, corresponding to a second media asset the first user has consumed, becomes closer to a predetermined amount (e.g., ‘1’). The media guidance application may repeat this process for each media asset vector corresponding to media assets the first user has consumed. Specifically, the media guidance application may take at each repetition a different one of the vectors as the output of the softmax classifier function and fire or trigger, as inputs to the function, the remaining vectors corresponding to the media assets consumed by the first user in the neural network. In some implementations, a dot product between two vectors that results in a lower value may indicate a stronger relationship between the two media assets corresponding to the vectors. For example, the media guidance application may retrieve a first vector for media asset M₁, a second vector for media asset M₂, a third vector for media asset M₃, and a fourth vector for media asset M₄, consumed by the first user. The media guidance application may adjust values stored in the first, second, third and fourth vectors in any dimension such that a dot product between any pair of the first, second, third and fourth vectors is decreased and becomes closer to the predetermined value. As discussed above, the media guidance application may use the gradient descent function to adjust the values of the vectors at each repetition.

After adjusting vector weights and/or modifying links in neural network 520 for the media assets consumed by the first user, the media guidance application may next identify a second set of media assets that have been viewed or consumed by a second user in the group. For example, as shown in FIG. 6, the media guidance application may identify media assets 612 M₂, M₄, and M₅ as media assets consumed by the second user.

Specifically, some of the media assets viewed by the first user may have also been viewed by the second user (e.g., M₄ and M₂). These media assets that the two users have in common viewing is referred to as a combination of media assets 610.

The media guidance application may add the media assets viewed by the second user to the neural network if they are not already in the neural network in the same or similar manner as discussed above for the first user. For example, media asset M₅ may not currently be represented in neural network 520. Accordingly, the media guidance application may add a node for that media asset to neural network 520. Specifically, the media guidance application may initiate a vector corresponding to the media asset not currently represented in neural network 520 and add the vector to the neural network. As discussed above, the media guidance application may associate links 630 for the newly added node with each media asset node corresponding to media assets consumed by the second user. As with the first user, the media guidance application may retrieve a sentiment vector for the newly added node and may adjust the value representing distances between the nodes based on the sentiment vector (e.g., based on the sentimental relationship between two nodes and/or an absolute sentiment value). The media guidance application may associate values for the links based on the retrieved factor or weight. In some embodiments, the values may be the same as those linking the nodes of media assets consumed by the first user. For example, the media guidance application may link the node for media asset M₅ with the nodes for media assets M₂ and M₄ already present in neural network 520 that the second user has consumed. The values assigned to those links may be five based on the retrieved factor or weight. Other media assets in the neural network that have not been viewed by the second user together with the newly added media asset may be linked to the newly added media asset node with links having an infinite value or very large value (not shown).

In some embodiments, the media guidance application may adjust or decrease the values that connect two or more media assets in a combination the more times that combination is viewed by different users. As discussed above, the media guidance application may, in addition or alternatively, adjust values stored in vectors for the media assets in the combination to make the distance represented by dot products of the vectors closer to each other. For example, if a media asset has already been added to the neural network, the media guidance application may determine whether the combination 610 of media assets (e.g., a combination of two media assets) that the second user consumed is also already in the neural network. Specifically, the media guidance application may determine that the combination of media assets M₄ and M₂ is already in neural network 520. Accordingly, the media guidance application may adjust or reduce the value (e.g., 5) of the link 620 that connects media assets M₄ and M₂ to a lower value (e.g., 4) to indicate these media assets are more closely related to each other. In some implementations, the amount by which the value of the link is reduced may correspond to the retrieved factor or weight (as adjusted based on the sentiment vectors if necessary). The media guidance application may adjust or reduce the value of each link that links two media assets that are in a combination of media assets that the second user has consumed and that is already in the neural network. Specifically, if a given combination of media assets the second user consumed is already linked in the neural network, this means that at least one other user has previously consumed the same combination of media assets. As such, the value of the link of the combination of media assets is adjusted or reduced for each user that has consumed the same combination indicating that the media assets in the same combination are closely related.

In some embodiments, the media guidance application may iteratively update the values of the vectors corresponding to media assets 612 using a gradient descent function based on the softmax classifier function. For example, at a first iteration, the media guidance application may apply as inputs to the softmax classifier function all of the vectors corresponding to the media assets in the neural network (e.g., M₁, M₃, M₄, M₅, . . . , Mₙ) except a first vector corresponding to a first of media assets 612 (e.g., M₂). Although all of the vectors except the first vector are input to the softmax classifier function, only those vectors that are input corresponding to media assets 612 consumed by the second user are triggered or fired (e.g., only M₄ and M₅ are triggered or fired). The first vector may be applied as the output of the softmax classifier function. The media guidance application may then use the gradient descent function to adjust the values of the first vector to increase the likelihood that when the input vectors are applied to the softmax classifier function, the first vector is approximated. In some implementations, the gradient descent function may also adjust the values of some or all of the vectors that are input to the softmax classifier function. This results in a distance represented by a dot product between a vector corresponding to one of media assets 612 that is used as an input and the first vector to be reduced (e.g., the relationship strength is increased). In some implementations, a given combination of media assets (e.g., M₄ and M₂) may have previously been consumed by the first user and the gradient descent may have previously adjusted values store in their corresponding vectors. Because the second user also consumed this combination, the gradient descent may be applied again to these vectors to further strengthen their relationship. Namely, the gradient descent may adjust their vector values such that when one of the two vectors is input to the softmax classifier function, the likelihood that the approximation matching the other of the two vectors is increased.

At a second iteration, the media guidance application may apply as inputs to the softmax classifier function all of the vectors corresponding to the media assets in the neural network (e.g., M₁, M₂, M₃, M₅, . . . , Mₙ) except a second vector corresponding to a second of media assets 612 (e.g., M₄). Although all of the vectors except the second vector are input to the softmax classifier function, only those vectors that are input corresponding to media assets 612 consumed by the second user are triggered or fired (e.g., only M₂, M₃ and M₄ are triggered or fired). The second vector may be applied as the output of the softmax classifier function. The media guidance application may then use the gradient descent function to adjust the values of the second vector to increase the likelihood that when the input vectors are applied to the softmax classifier function, the second vector is approximated. In some implementations, the gradient descent function may also adjust the values of some or all of the vectors that are input to the softmax classifier function. This results in a distance represented by a dot product between a vector corresponding to one of media assets 612 that is used as an input and the second vector to be reduced (e.g., the relationship strength is increased). The media guidance application may continue these iterations until every vector corresponding to one of media assets 612 consumed by the second user is applied as an output to the softmax classifier function and has its corresponding values adjusted using gradient descent.

In some embodiments, the media guidance application may only consider the sentiment vectors for selecting the amount by which a distance between the media asset vectors is adjusted for media assets in a combination. If a given media asset is not part of a combination, the media guidance application may not consider the sentiment vector associated with that media asset. For example, the media guidance application may not use the sentiment vector for the second user associated with newly added media asset M₅ because this media asset is not present in a combination (e.g., was not viewed together with another media asset that the second user has consumed by another user). For this media asset, the media guidance application may apply a default amount when adjusting a distance between the vector corresponding to this media asset and the other media asset vectors of the media assets the second user has consumed. However, the media guidance application may retrieve sentiment vectors for the second user associated with media assets M₄ and M₂ because these media assets are in a combination consumed by another user. When adjusting a distance between vectors for these media assets, the media guidance application may compute a sentimental relationship value and/or an absolute sentiment value to determine by how much to adjust the distance in a similar manner as discussed above.

In some embodiments, after identifying the media assets consumed by the second user, the media guidance application may apply the same function as that which was applied to the media assets consumed by the first user to those consumed by the second user. Specifically, the media guidance application may adjust a distance between each vector corresponding to media assets consumed by the second user in accordance with equation 1. Any media asset vector that was previously processed to reduce its distance with another media asset vector using the function (e.g., because the two vectors correspond to the combination of media assets) may be processed again using the function (e.g., because the same combination appears in the media assets consumed by the second user). As a result, a distance between the two vectors corresponding to the media assets in the combination will be adjusted twice (e.g., reduced twice)—once because the media assets were identified as being consumed by the first user and then again because the same media assets were identified as being consumed by the second user. A distance between vectors of the other media assets the second user consumed may also be adjusted using the function (e.g., gradient descent function). Namely, the function may be repeatedly applied for each media asset vector corresponding to media assets the second user consumed such that distances between those vectors are adjusted (reduced).

Alternatively or in addition, the media guidance application may adjust values stored in vectors for M₄ and M₂ to make the vectors closer to each other (e.g., such that the dot product of the vectors is closer to a predetermined value such as ‘1’). Similarly, the media guidance application may adjust values stored in the vectors for media asset M₂, M₄, and M₅ to make these vectors closer to each other (e.g., such that the dot product of the vectors is closer to a predetermined value such as ‘1’). If the media guidance application adjusts the values stored in vectors M₂ and M₄ to make them closer to M₅, the media guidance application may also adjust the values of the other media assets to ensure that a distance between M₂ and M₄ and the other media asset vectors is unchanged.

After adjusting vector weights and/or modifying links in neural network 520 for the media assets consumed by the first and second users, the media guidance application may next identify a third set of media assets that have been viewed or consumed by a third user in the group. For example, as shown in FIG. 7, the media guidance application may identify media assets M₁, M₂, M₄ and M₅ as media assets consumed by the third user. Specifically, some of the media assets viewed by the first user may have also been viewed by the third user (e.g., M₁, M₂ and M₄). These media assets that the two users have in common viewing are referred to as a combination of media assets 710. In addition, some of the media assets viewed by the second user may have also been viewed by the third user (e.g., M₂, M₄ and M₅). These media assets that the two users have in common viewing are also referred to as a combination of media assets 720.

The media guidance application may determine that the combination of media assets M₁, M₂ and M₄ are already in neural network 520. Accordingly, the media guidance application may adjust or reduce the values of the links that connect media assets M₁, M₂ and M₄ to a lower value to indicate these media assets are more closely related to each other in a similar manner as discussed above. For example, the media guidance application may adjust or reduce the value (e.g., 4) of the link 732 that connects media assets M₂ and M₄ to a lower value (e.g., 3). Similarly, the media guidance application may adjust or reduce the value (e.g., 5) of the link that connects media assets M₂ and M₁ to a lower value (e.g., 4) and the value (e.g., 5) of the link that connects media assets M₄ and M₁ to a lower value (e.g., 4). In some implementations, the amount by which the value of the link is reduced may correspond to the retrieved factor or weight (e.g., alpha₁). Similarly, the media guidance application may adjust or reduce the value (e.g., 5) of the link 730 that connects media assets M₅ and M₄ to a lower value (e.g., 4) since these two media assets are in the combination 720 of media assets that were also consumed by the second user.

As discussed above, the media guidance application may adjust or reduce values stored in vectors corresponding to each media asset the third user has consumed that are in the combination to make the vectors closer to each other based on the function (e.g., using equation 1 and the gradient descent function). For example, the media guidance application may adjust values stored in vectors for combination 710 of media assets to make the vectors closer to each other. Specifically, the media guidance application may adjust values stored in vectors for combination 710 of media assets such that a dot product between any two vectors in the combination is lower or closer to a predetermined value (e.g., ‘1’). Similarly, the media guidance application may adjust values stored in vectors for combination 720 of media assets to make the vectors closer to each other. Specifically, the media guidance application may adjust values stored in vectors for combination 720 of media assets such that a dot product between any two vectors in the combination is lower or closer to a predetermined value (e.g., ‘1’).

The media guidance application may continue updating the neural network in this manner for each user in the group. In some implementations, the media guidance application may multiply the values that represent the closeness of the relationship of each media asset to each other in the neural network by a weight. As referred to herein, updating values in a neural network representing the closeness in relationship between two media assets may be represented by adjusting values stored in n-dimensional vectors for the two media assets such that the dot product between the vectors is closer or farther away from a given value (e.g., ‘1’). Namely, to make the relationship between the two media assets closer, the values in the vector may be adjusted so that the dot product is closer to ‘1’ and to make the relationship between the two media assets farther or weaker, the values in the vector may be adjusted so that the dot product is farther away from ‘1’.

In some embodiments, after generating neural network 520 based on the viewing activity of the users in the group, the media guidance application may update the link values indicating relationships between media assets based on metadata associated with the media assets. For example, the media guidance application may select one of a plurality of metadata attributes (e.g., actor). The media guidance application may identify a group of media assets that are associated with the selected attribute. The media guidance application may then decrease the value of the links that connect each media asset in the group of media assets that are associated with the selected attribute to make them more closely related in the neural network. The value by which the links are decreased may be multiplied by a factor or weight (e.g., alpha₂), which may or may not be the same as the factor or weight used to link the media assets based on media consumption. Accordingly, media assets that are in the group associated with the selected attribute in the neural network may be identified as being more closely related than initially (e.g., before the attribute was selected to increase the values of the links of media assets having the selected attribute). For example, if the same actor appears in media assets M₁ and M₄, the link joining these two media assets may be decreased from one value to another. The process of adjusting vector values for media assets corresponding to the attribute may be the same or similar as that which is performed when a given set of media assets is consumed by a particular user (e.g., using the softmax classification function or equation 1 and the gradient descent function).

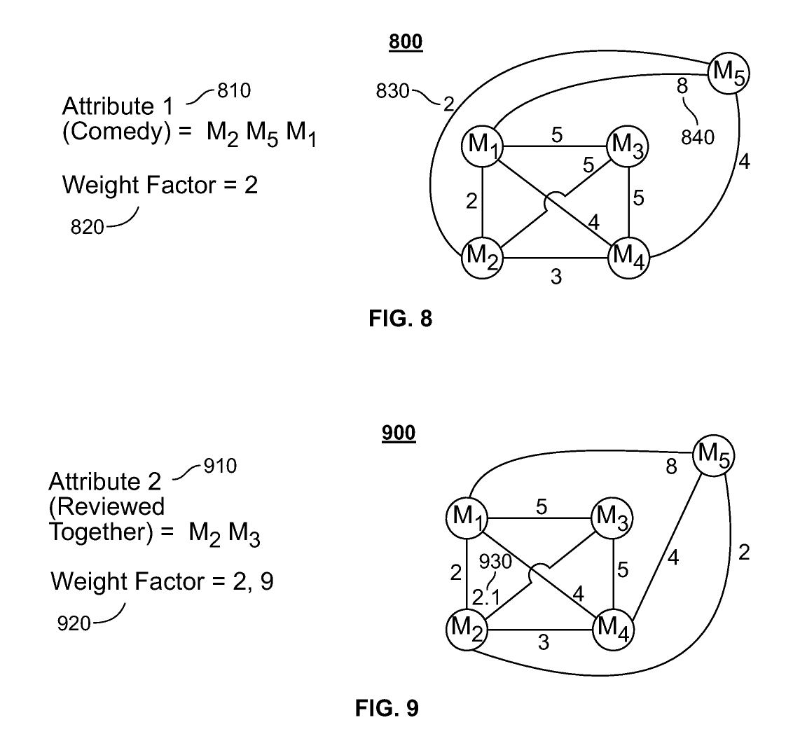

FIGS. 8 and 9 show illustrative updates to a neural network of media assets based on media attributes in accordance with some embodiments of the disclosure. For example, the media guidance application may select a first attribute 810 (e.g., a genre that is comedy). The media guidance application may cross-reference a database to identify a group of media assets that are associated with first attribute 810. The database may return to the media guidance application the group of media assets (e.g., M₁, M₅ and M₁). The media guidance application may cross-reference a database of factors or weights associated with first attribute 810 to determine what weight or factor to use in adjusting the neural network links. For example, the database may indicate that the selected first attribute 810 is associated with first weight or factor 820 (e.g., having a value ‘2’). The weight or factor may be applied to the function used to adjust vector values to make the vectors closer to each other in distance in the same or similar manner as discussed above for when a given set of media assets has been consumed by a user (e.g., using equation 1 and the gradient descent function).

In some implementations, after identifying first weight or factor 820 and the group of media assets associated with first attribute 810, the media guidance application may determine whether the group of media assets are in neural network 520 (e.g., the neural network generated based on the group of users' media consumption). The media guidance application may adjust the links in neural network 520 that join each of the media assets in the group based on first weight or factor 820. In some embodiments, if a given media asset in the group of media assets is not linked to another media asset in the group in the neural network, the media guidance application may create a link having a weight determined based on a predetermined value or first weight or factor 820.

For example, the media guidance application may adjust the link joining one media asset M₂ in the group with another media asset M₁ in the group based on the first weight or factor 820. Specifically, the link in neural network 520 may currently be associated with a value (e.g., 4) and after being adjusted (e.g., reduced by the value ‘2’ of first weight or factor 820), the link may be associated with a lower value (e.g., 2). Accordingly, media asset M₂ may be determined to be more closely related to media asset M₁ based on the updated link. Similarly, the link joining media asset M₂ with media asset M₅ in the group may be adjusted based on first weight or factor 820 such that the value of the link is reduced from the value ‘4’ to the value ‘2’. The media guidance application may determine that no link is currently present in neural network 520 that joins media asset M₁ with media asset M₅. In such circumstances, the media guidance application may generate a link joining these two media assets having a value determined based on first weight or factor 820. For example, the media guidance application may retrieve a maximum value (e.g., 10) for joining media assets indicating that the media assets are not closely related and may reduce that maximum value by first weight or factor 820. Specifically, the media guidance application may join media asset M₁ with media asset M₅ with a link having a value ‘8’ (the maximum value 10 reduced by first weight or factor 180 valued at 2).

As discussed above in connection with FIGS. 5-7, instead of or in addition to updating links joining media assets in neural network 520, the media guidance application may update values stored in vectors associated with media assets to indicate that the media assets are more closely related. This may be performed by applying a function (e.g., the softmax classification function and the gradient descent function) to the vectors corresponding to the media assets associated with the attribute to adjust their values so the distance represented by dot products of the vectors is reduced. For example, the media guidance application may retrieve from storage 308 vectors of values corresponding to each media asset in the group associated with first attribute 810. These vectors or values may have been previously updated based on the group of users' media consumption. The media guidance application may adjust the values stored in the vectors based on first weight or factor 820. For example, the media guidance application may reduce the values stored in the vectors corresponding to media assets M₂, M₅, and M₁ based on first weight or factor 820 such that a dot product between any two vectors in the group is closer to a predetermined value (e.g., ‘1’) than before the values were reduced.

In some embodiments, after updating the media assets in the group associated with the selected attribute, another attribute may be selected for updating the corresponding media asset links in neural network 520. The updates to the links between media assets based on the second attribute may be weighted more or less heavily than those performed based on the first attribute. For example, if the second attribute is genre and the first attribute is actor, the links between media assets in the group that share a genre attribute may be increased by a value greater than the value by which the links that are updated for media assets in a group that shares an actor attribute. This may be beneficial if the second attribute is indicative of media assets being related to each other more than the first attribute. Specifically, it may be more likely that media assets that share a genre attribute are more closely related than media assets that share an actor attribute.

In some implementations, the media guidance application may cross-reference a database to identify a group of media assets that are associated with second attribute 910 (FIG. 9). The database may return to the media guidance application the group of media assets (e.g., M₂ and M₃). The media guidance application may cross-reference a database of factors or weights associated with second attribute 910 to determine what weight or factor to use in adjusting the neural network links. For example, the database may indicate that the selected second attribute 910 is associated with second weight or factor 920 (e.g., having a value ‘2.9’).

In some implementations, after identifying second weight or factor 920 and the group of media assets associated with second attribute 910, the media guidance application may determine whether the group of media assets are in neural network 520 (e.g., the neural network generated based on the group of users' media consumption and first attribute 810). The media guidance application may adjust the links in neural network 520 that join each of the media assets in the group based on second weight or factor 920.

For example, the media guidance application may adjust the link joining media asset M₂ in the group with another media asset M₃ in the group based on the second weight or factor 920. Specifically, the link in neural network 520 may currently be associated with a value (e.g., 5) and after being adjusted (e.g., reduced by the value ‘2.9’ of first weight or factor 920), the link may be associated with a lower value (e.g., 2.1). Accordingly, media asset M₂ may be determined to be more closely related to media asset M₃ based on the updated link.

As discussed above, instead of or in addition to updating links joining media assets in neural network 520, the media guidance application may update values stored in vectors associated with media assets to indicate that the media assets are more closely related. For example, the media guidance application may retrieve from storage 308 vectors of values corresponding to each media asset in the group associated with second attribute 910. These vectors or values may have been previously updated based on the group of users' media consumption and first attribute 810. The media guidance application may adjust the values stored in the vectors based on second weight or factor 920. This may be performed in a similar manner as that which is performed for adjusting vector values for media assets associated with the first attribute, as discussed above. For example, the media guidance application may reduce the values stored in the vectors corresponding to media assets M₂ and M₃ based on second weight or factor 920 such that a dot product between the two vectors in the group is closer to a predetermined value (e.g., ‘1’) than before the values were reduced.

As referred to herein, the term “attribute” includes any content that describes or is associated with a media asset. The attribute may include a genre, category, content source, title, series information or identifier, characteristic, actor, director, cast information, crew, location, description, rating, length or duration, transmission time, availability time, sponsor, and/or any combination thereof.

In some embodiments, after generating the neural network based on the viewing activity of the users in the group and/or after updating the neural network based on attributes, the media guidance application may update the link or vector values indicating relationships between media assets based on input received from one or more users. For example, the media guidance application may process input (e.g., verbal or written) received from a user that includes a review about one or more media assets or social network feed associated with the media assets. Specifically, the media guidance application may process textual input received from a user by a server that is made available to a plurality of other users (e.g., friends of the user or the general public).

In some embodiments, the media guidance application may receive inputs (e.g., verbal or written) from multiple users and select one of multiple inputs for further processing. For example, the media guidance application may select one of the inputs that include a review and/or social network feed associated with a given user and convert the input into textual form if necessary. The media guidance application may identify a group of media assets that are associated with the review and/or social network feed associated with the given user. For example, the media guidance application may identify a group of media assets that are mentioned in the textual form of the received input. In some implementations, the media guidance application may only identify a group of media assets mentioned in a single textual communication (e.g., a single review) and/or textual communications (e.g., multiple reviews or social network posts) that were received over a predetermined time period. Specifically, a given user may have written a review about a first media asset (e.g., Seinfeld) and may have mentioned one or more other media assets (e.g., Friends). Because the user mentioned multiple assets in the same communication or input and/or in the communications received within a given time period, there is a strong likelihood that these assets are related to each other.

The media guidance application may retrieve a weight or factor from storage 308 that is associated with the form of communication. For example, the media guidance application may retrieve a first weight or factor for social network posts and a different second weight or factor for user reviews. The media guidance application may then adjust (e.g., decrease) the value of the links that connect each media asset in the group of media assets that are associated with the selected review and/or social network feed, and/or the corresponding vector values, in the manner discussed above. The value by which the links or vector values may be adjusted based on the retrieved factor or weight (e.g., alpha₃). The factor or weight used to adjust the links and/or vector values may be different from the weight or factor used to adjust the links and/or vector values for media assets corresponding to a given attribute or consumed by a given user. Accordingly, media assets that are in the group associated with the selected review and/or social network feed in the neural network may be identified as being more closely related than initially (e.g., before the review and/or social network feed was selected to increase the values of the links of media assets having the selected review and/or social network feed). For example, if the same review and/or social network feed discusses media assets M₁ and M₄, the link joining these two media assets may be decreased from a first value to a third value (a value different from the value used to increase the weights due to a combination of media assets that different users consume). The third value may be greater than or less than the second value (i.e., the value used to increase the weights due to a combination of media assets that different users consume).

In some embodiments, after updating the media assets in the group associated with the selected review and/or social network feed, another review and/or social network feed may be selected for updating the corresponding media asset links in the neural network and/or corresponding vector values.

In some embodiments, the neural network may be represented as a set of vectors that are each generated with values based on media asset consumption information and/or attribute information. For example, each media asset may be associated with a vector that includes a plurality of other media assets in the neural network. Each of the plurality of other media assets in the vector may include a weight that specifies how closely related the given media asset is to the media asset associated with the vector. Specifically, a given media asset M₁ may be associated with a vector of other media assets [M₂ M₃ M₅ M₆]. Each of the media assets in the vector M₂ M₃ M₅ M₆ may include a weight that represents how closely related these media assets are to M₁.

In some embodiments, the vectors for each media asset may represent each other media asset that has been consumed by some user together with the respective media asset. Specifically, the vector for a first media asset may include each other media asset that has been consumed together with the first media asset by at least one user. If more than one user has consumed a combination of the first media asset and a second media asset in the corresponding vector, the weight of the second media asset in the vector for the first media asset may be increased. Accordingly, the greater the number of users that consumed the combination of the first and second media assets, the greater the weight of the second media asset in the first media asset vector indicating these two media assets are more closely related. When the media asset vectors are generated in this manner, the closeness may be determined based on how great the weight is that is associated with a given media asset vector value rather than computing a dot product of two vectors. Specifically, to determine the strength of the relationship between two media assets, the media guidance application may identify a single weight associated with a particular dimension for a given media asset vector. Larger weights indicate stronger relationships. In some implementations (discussed above), multi-dimensional vectors are used where the dimensions in each vector do not depend on the number of other media assets. In such circumstances, the strength of the relationship may be determined by computing a dot product of two media asset vectors to determine how close or far the dot product result is to a given value (e.g., ‘1’). In other implementations, each media asset is associated with a vector that has dimensions for each other media asset that is available in the system. In these implementations, the strength of the relationship may be determined by the media guidance application retrieving a weight associated with a given dimension and determining if it is larger or smaller than another weight in another dimension that is associated with a different media asset.

For example, the vectors may be generated by first retrieving a list of media assets that have been consumed by a first user. In particular, the first user may have consumed media assets M₁, M₂, and M₃. Accordingly, three vectors, one for each media asset, may be generated that include the media assets that have been consumed by the first user: first vector may be M₁=[M₂ M₃], second vector may be M₂=[M₁ M₃], and third vector may be M₃=[M₁ M₂]. Next, the list of media assets that have been consumed by a second user may be retrieved and identified as M₂, M₃ and M₄. For each media asset the second user consumed, a determination is made as to whether a vector for that media asset already exists. If it is determined that a vector for a media asset already exists, then the vector is retrieved and processed to determine whether the other media assets the second user consumed are already included in the vector. For any media asset that is already included in the vector, the corresponding weight may be increased. For any media asset that is not already included in the vector, the respective media asset may be added to the vector with a nominal weight. If it is determined that a vector for a media asset does not already exist, then a new vector for the media asset may be generated that includes all of the other media assets the second user has consumed with nominal weights.

For example, it may be determined that media asset M₂ consumed by the second user already has a vector (e.g., because the first user has consumed M₂). Accordingly, a determination is made as to whether the media assets in the vector for M₂ include any of the other media assets M₃ and M₄ that the second user has consumed. The vector for M₂=[0.1M₁ 0.1M₃] and thus the only media asset consumed by the second user that is already in the vector is M₃. Accordingly, the weight for the media asset M₃ in the vector for M₂ may be increased by a predetermined amount (e.g., from 0.1 to 0.2). Since the other media asset M₄ is not already in the vector for M₂, the media asset may be added to the vector. As such, the resulting vector for M₂ may be M₂=[0.1M₁ 0.2M₃ 0.1M₄]. Similarly, it may be determined that media asset M₃ consumed by the second user already has a vector (e.g., because the first user has consumed M₃). Accordingly, a determination is made as to whether the media assets in the vector for M₃ include any of the other media assets M₂ and M₄ that the second user has consumed. The vector for M₃=[0.1M₁ 0.1M₂] and thus the only media asset consumed by the second user that is already in the vector is M₂. Accordingly, the weight for the media asset M₂ in the vector for M₃ may be increased by a predetermined amount (e.g., from 0.1 to 0.2). Since the other media asset M₄ is not already in the vector for M₃, the media asset may be added to the vector. As such, the resulting vector for M₃ may be M₃=[0.1M₁ 0.2M₃ 0.1M₄]. Finally, it may be determined that media asset M₄ consumed by the second user does not already have a vector (e.g., because the first user has not consumed M₄). Accordingly, a new vector for media asset M₄ may be generated that includes the media assets that have been consumed by the second user: fourth vector may be M₄=[M₂ M₃] with nominal weights (e.g., 0.1) for each media asset that has been added. This process of updating existing vectors and generating new vectors may be repeated for each user in a group of users and the media assets consumed by the group of users.

In some embodiments, after generating the vectors based on the viewing activity of the users in the group, the media guidance application may update the values in the vectors indicating relationships between media assets based on metadata associated with the media assets. For example, the media guidance application may select one of a plurality of metadata attributes (e.g., actor). The media guidance application may identify a group of media assets that are associated with the selected attribute. The media guidance application may then increase the value of the weights of the media assets in the vectors for the other media assets in the group associated with the selected attribute in a similar manner as discussed above for increasing weights of media assets when the same combination of media assets have been consumed by more than one user. The value by which the weights are increased may be more or less than the amount used to increase the weight when more than one user has consumed a combination of media assets. For example, if the media assets in the group associated with a given actor attribute include M₁ and M₄, the media guidance application may retrieve the vectors for M₁ and M₄. The media guidance application may process the vector for M₁ to determine whether the other media assets in the group are already included in the vector. Specifically, the media guidance application may determine whether the media asset M₄ is already included in the vector for M₁. If it is, then the corresponding weight may be increased by a threshold amount. If the media asset M₄ is not already included in the vector for M₁, then the media asset M₄ is added to the vector for the media asset M₁. Similarly, the media guidance application may process the vector for M₄ to determine whether the other media assets in the group are already included in the vector.

In some implementations, the media guidance application may determine whether the media asset M₁ is already included in the vector for M₄. If it is, then the corresponding weight may be increased by a threshold amount. If the media asset M₁ is not already included in the vector for M₄, then the media asset M₁ is added to the vector for the media asset M₄. This process of updating media asset vectors for media assets in a group corresponding to a given attribute may be repeated for any number of attributes and/or user input (e.g., reviews or social network communications (posts).

In some embodiments, the media guidance application may generate a media asset recommendation to a user based on the neural network and/or vectors corresponding to the media assets in the neural network. For example, the media guidance application may retrieve a viewing history for a given user. The media guidance application may use the function that models the neural network relationships (e.g., the softmax classifier function) to identify an approximation of the media assets the given user consumed. For example, the media guidance application may apply as inputs to the softmax classifier function some or all of the vectors corresponding to media assets the given user consumed along with all of the other media assets in the neural network. The media guidance application may only fire or trigger those media assets the given user has consumed. The softmax classifier function may then output an approximation of a vector that results when the media asset vectors corresponding to the media assets the given user consumed are triggered or fired. This approximation of the vector is then processed to identify a list of candidate media assets having vectors that correspond to the approximated vector. The media guidance application may select one or more of these candidate media assets to generate a recommendation for the given user.

In some embodiments, the media guidance application may generate a media asset recommendation by selecting a media asset from the viewing history. For example, the media guidance application may select a recently consumed media asset or a media asset that matches strongly to the profile of the given user. The media guidance application may apply the selected media asset to the neural network to identify a plurality of candidate media assets that are linked to the media asset in the neural network. Specifically, the media guidance application may determine which media asset nodes correspond to the selected media asset node when the selected node is triggered or fired. In some implementations, the media guidance application may use the vectors of other media assets to identify the candidate media assets based on the vectors. Specifically, the media guidance application may identify the candidate media assets by computing a distance (e.g., using a dot product) between each vector of media assets in the neural network to the given media asset vector. The media guidance application may select as the candidate media assets those media assets having a vector that is at a distance away from the vector of the given media asset that is less than a predetermined amount.

In some implementations, the media guidance application may select only those media assets in the neural network that are linked to the given media asset by links having a value less than a predetermined value. Specifically, the media guidance application may only select candidate media assets that are strongly related to the given media asset according to the neural network. The media guidance application may exclude from the candidate media assets those media assets that are already in the given user's viewing history. In particular, the media guidance application may only include as part of the candidate media assets those media assets that the given user has not yet consumed. The media guidance application may select one of the media assets in the plurality of candidate media assets to generate a recommendation to the given user to view the selected media asset.

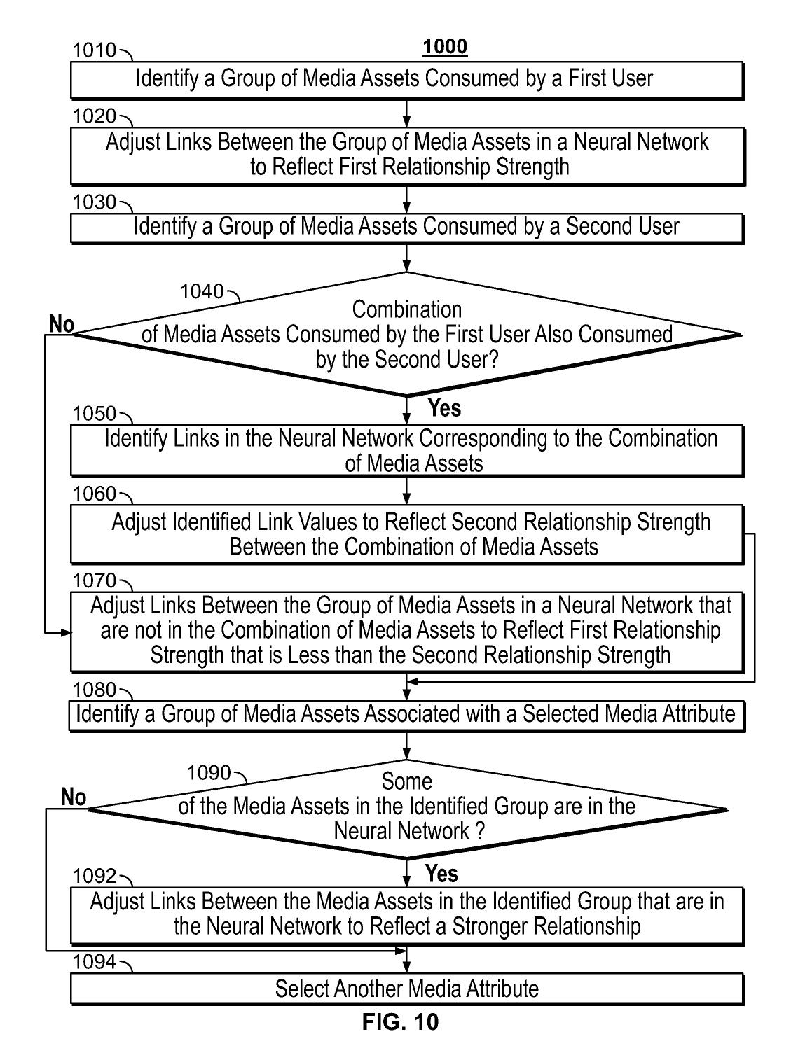

FIG. 10 is a diagram of a process 1000 for updating a neural network of media assets in accordance with some embodiments of the disclosure. At step 1010, a group of media assets consumed by a first user is identified. For example, the media guidance application may retrieve from storage 308 a viewing history associated with a first user. The viewing history may indicate that the first user has viewed media assets 510 (FIG. 5).

At step 1020, links between the group of media assets in a neural network are adjusted to reflect a first relationship strength. For example, the media guidance application may add the identified media assets to neural network 520 if the media assets are not already in the neural network. Each media asset that is added to the neural network may be linked to each other media asset that is in the neural network. The media guidance application may assign weights or values 524 to the links between each of the media assets that are in the identified group of media assets the first user consumed based on a first weight or factor retrieved from a database. In some implementations, the neural network may be represented by vectors associated with each media asset. In such circumstances, the media guidance application may adjust or reduce values stored in the vectors for the media assets the first user consumed to reduce a distance between the media assets (e.g., in accordance with the softmax classifier function and the gradient descent function).

In some implementations the distance may be adjusted based on the retrieved weight or factor. In some implementations, the values may be adjusted such that a dot product between vectors of the media assets the first user consumed is closer to a predetermined value (e.g., ‘1’). In some implementations, the weight or factor may be determined based on sentimental vectors, of the user, associated with the media assets. For example, the weight or factor may depend on a sentimental relationship between the two media assets and/or an absolute sentimental value of a user for at least one of the two media assets determined based on the sentimental vectors.

At step 1030, a group of media assets consumed by a second user is identified. For example, the media guidance application may retrieve from storage 308 a viewing history associated with a second user. The viewing history may indicate that the second user has viewed a set of media assets shown FIG. 6.

At step 1040, a determination is made as to whether the combination of media assets consumed by the first user was also consumed by the second user. In response to determining that the combination consumed by the first user was also consumed by the second user, the process proceeds to step 1050; otherwise, the process proceeds to step 1070. For example, the media guidance application may determine whether a combination of at least two media assets consumed by the second user is already in neural network 520. Specifically, if a combination of at least two media assets consumed by the second user is already in neural network 520 and have links with less than a predetermined value (e.g., less than or equal to the first relationship strength), the media guidance application may determine that at least one other user has also consumed the same combination. In some implementations, the media guidance application may revisit or review media assets consumed by other users to determine whether any overlap exists between at least two media assets consumed by the second user and the media assets consumed by any other user. In some implementations, the determination may include performing the same function on the media asset vectors corresponding to the media assets consumed by the second user as that which was performed for the media asset vectors corresponding to the media assets consumed by the first user. By performing the same function on the media asset vectors, any two or more media assets in the combination that were consumed by the first and second users may have their corresponding media asset vector values adjusted such that the vectors are closer to each other in distance than those media assets that are not in the combination.

At step 1050, links in the neural network corresponding to the combination of media assets are identified. For example, the media guidance application may determine that combination of media assets 610 consumed by the second user has also been consumed by the first user (FIG. 6). The media guidance application may identify the links in neural network 520 joining the media assets in combination of media assets 610. In some embodiments, the links may be identified by retrieving media asset vectors corresponding to the identified media assets.

At step 1060, the identified link values are adjusted to reflect a second relationship strength between the combination of media assets. For example, the media guidance application may retrieve a weight or factor from a database for updating or adjusting link values for a combination of media assets consumed by multiple users. The media guidance application may adjust or reduce the link values of the links that join the media assets in the combination based on the retrieved weight or factor. In some implementations, the media guidance application may adjust or reduce values stored in vectors corresponding to the media assets in the combination based on the retrieved weight or factor (e.g., in accordance with the softmax classifier function and the gradient descent function). In particular, the media guidance application may reduce the values stored in the corresponding vectors such that a dot product between the two vectors becomes closer to the predetermined value (e.g., ‘1’). In some embodiments, the weight or factor may depend on sentiment vectors of the second user for the corresponding media assets in the combination. In some implementations, the sentiment vectors may only be considered when selecting by how much to adjust a distance for media assets in the combination and not for media assets that are not in the combination.

At step 1070, links between the group of media assets in the neural network that are not in the combination of media assets are adjusted to reflect the first relationship strength that is less than the second relationship strength.

At step 1080, a group of media assets associated with a selected media attribute is identified. For example, the media guidance application may select a first attribute 810 (FIG. 8) and identify a group of media assets that correspond to the selected attribute.

At step 1090, a determination is made as to whether some of the media assets in the identified group are in the neural network. In response to determining that some of the media assets in the group are in the neural network, the process proceeds to step 1092, otherwise the process proceeds to step 1094. For example, the media guidance application may determine whether a combination of at least two media assets associated with the first attribute is already in neural network 520.

At step 1092, links between the media assets in the identified group corresponding to the selected attribute that is in the neural network are adjusted to reflect a stronger relationship (e.g., a third relationship). For example, the media guidance application may retrieve a weight or factor from a database for updating or adjusting link values for media assets associated with a selected attribute. The media guidance application may adjust or reduce the link values of the links that join the media assets in the combination based on the retrieved weight or factor to represent a stronger relationship between the media assets. In some implementations, the media guidance application may adjust or reduce values stored in vectors corresponding to the media assets in the combination based on the retrieved weight or factor. In particular, the media guidance application may reduce the values stored in the corresponding vectors such that a dot product between the two vectors becomes closer to the predetermined value (e.g., ‘1’).

At step 1094, another media attribute is selected. For example, the media guidance application may select a second attribute 910 (FIG. 9).

The above-described embodiments of the present disclosure are presented for purposes of illustration and not of limitation, and the present disclosure is limited only by the claims that follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

1. A method for maintaining a model representing media asset relationships, the method comprising:
identifying a combination of media assets consumed by a first user, wherein a first media asset in the combination is associated with a first vector of values and a second media asset in the combination is associated with a second vector of values, and wherein a distance between the first vector and the second vector is a first amount;
determining whether a second user consumed the combination of media assets; and
in response to determining that the second user consumed the combination of media assets, adjusting the values stored in the first and second media asset vectors such that the distance between the first media asset vector and the second media asset vector is reduced to a second amount that is less than the first amount.

2. The method of claim 1, wherein the distance is determined based on a dot product between the first media asset vector and the second media asset vector.

3. The method of claim 1, wherein the distance between the first and second vectors is indicative of a contextual relationship between the first and second media assets, further comprising:
retrieving a sentiment vector for each of the first and second media assets in the combination;
computing a distance between the sentiment vectors of the first and second media assets;
computing a first absolute value representing sentiment for the first media asset and a second absolute value for the second media asset based on the sentiment vectors; and
setting the second amount based on at least one of the distance between the sentiment vectors and the first and second absolute values.

4. The method of claim 1, wherein the distance is reduced by a first factor, further comprising:
identifying a plurality of media assets corresponding to an attribute, each of the plurality of media assets being associated with a respective vector of values; and
adjusting the values stored in the respective vectors of the plurality of media assets such that a distance between each of the respective vectors is reduced by a second factor.

5. The method of claim 4, further comprising:
determining whether the plurality of media assets includes the first and second media assets; and
in response to determining that the plurality of media assets includes the first and second media assets, adjusting the values stored in the first and second media asset vectors such that the distance between the first media asset vector and the second media asset vector is reduced to a third amount that is less than the second amount.

6. The method of claim 1 further comprising:
processing input received from a third user to determine whether text corresponding to the input includes the combination of the first and second media assets;
in response to determining that the combination of the first and second media assets are included in the input, adjusting the values stored in the first and second media asset vectors such that the distance between the first media asset vector and the second media asset vector is reduced to a third amount that is less than the second amount.

7. The method of claim 1, wherein:
the identifying the combination of media assets consumed by the first user comprises:
retrieving the first and second vectors associated with the first and second media assets consumed by the first user; and
adjusting values stored in the first and second vectors based on a softmax classifier function and a gradient descent function such that the distance between the first and second vectors is the first amount;
the determining comprises identifying a plurality of media assets consumed by the second user, wherein the plurality of media assets include the first and second media assets; and
the adjusting comprises applying the softmax classifier function and the gradient descent function to vectors corresponding to the plurality of media assets to adjust a distance between the vectors corresponding to the plurality of media assets such that the distance between the first and second vectors is reduced to the second amount.

8. The method of claim 1 further comprising:
identifying a plurality of media assets consumed by a third user;
selecting a given media asset from the plurality of media assets, the given media asset being associated with a third vector of values;
identifying, using the model, a plurality of candidate media assets, not previously consumed by the third user, associated with vectors of values that are within a threshold distance of the third vector.

9. The method of claim 8 further comprising generating a recommendation to the third user based on the plurality of candidate media assets, wherein the plurality of media assets includes the first media asset but not the second media asset, wherein the second media asset is in the plurality of candidate media assets, further comprising generating a recommendation of the second media asset to the third user.

10. The method of claim 1, wherein a distance between the first and second vectors is adjusted using at least one of a gradient decent function and a softmax classifier function.

11. A system for maintaining a model representing media asset relationships, the system comprising:
control circuitry configured to:
identify a combination of media assets consumed by a first user, wherein a first media asset in the combination is associated with a first vector of values and a second media asset in the combination is associated with a second vector of values, and wherein a distance between the first vector and the second vector is a first amount;
determine whether a second user consumed the combination of media assets; and
in response to determining that the second user consumed the combination of media assets, adjust the values stored in the first and second media asset vectors such that the distance between the first media asset vector and the second media asset vector is reduced to a second amount that is less than the first amount.

12. The system of claim 11, wherein the distance is determined based on a dot product between the first media asset vector and the second media asset vector.

13. The system of claim 11, wherein the distance between the first and second vectors is indicative of a contextual relationship between the first and second media assets, and wherein the control circuitry is further configured to:
retrieve a sentiment vector for each of the first and second media assets in the combination;
compute a distance between the sentiment vectors of the first and second media assets;
compute a first absolute value representing sentiment for the first media asset and a second absolute value for the second media asset based on the sentiment vectors; and
set the second amount based on at least one of the distance between the sentiment vectors and the first and second absolute values.

14. The system of claim 11, wherein the distance is reduced by a first factor, and wherein the control circuitry is further configured to:
identify a plurality of media assets corresponding to an attribute, each of the plurality of media assets being associated with a respective vector of values; and
adjust the values stored in the respective vectors of the plurality of media assets such that a distance between each of the respective vectors is reduced by a second factor.

15. The system of claim 14, wherein the control circuitry is further configured to:
determine whether the plurality of media assets includes the first and second media assets; and
in response to determining that the plurality of media assets includes the first and second media assets, adjust the values stored in the first and second media asset vectors such that the distance between the first media asset vector and the second media asset vector is reduced to a third amount that is less than the second amount.

16. The system of claim 11, wherein the control circuitry is further configured to:
process input received from a third user to determine whether text corresponding to the input includes the combination of the first and second media assets;
in response to determining that the combination of the first and second media assets are included in the input, adjust the values stored in the first and second media asset vectors such that the distance between the first media asset vector and the second media asset vector is reduced to a third amount that is less than the second amount.

17. The system of claim 11, wherein the control circuitry is further configured to identify the combination of media assets consumed by the first user by:
retrieving the first and second vectors associated with the first and second media assets consumed by the first user; and
adjusting values stored in the first and second vectors based on a softmax classifier function and a gradient descent function such that the distance between the first and second vectors is the first amount;
the control circuitry is further configured to perform the determination by identifying a plurality of media assets consumed by the second user, wherein the plurality of media assets include the first and second media assets; and
the control circuitry is further configured to perform the adjustment by applying the softmax classifier function and the gradient descent function to vectors corresponding to the plurality of media assets to adjust a distance between the vectors corresponding to the plurality of media assets such that the distance between the first and second vectors is reduced to the second amount.

18. The system of claim 11, wherein the control circuitry is further configured to:
identify a plurality of media assets consumed by a third user;
select a given media asset from the plurality of media assets, the given media asset being associated with a third vector of values;
identify, using the model, a plurality of candidate media assets, not previously consumed by the third user, associated with vectors of values that are within a threshold distance of the third vector.

19. The system of claim 18, wherein the control circuitry is further configured to generate a recommendation to the third user based on the plurality of candidate media assets, wherein the plurality of media assets includes the first media asset but not the second media asset, wherein the second media asset is in the plurality of candidate media assets, and wherein the control circuitry is further configured to generate a recommendation of the second media asset to the third user.

20. The system of claim 11, wherein a distance between the first and second vectors is adjusted using at least one of a gradient decent function and a softmax classifier function.

21-50. (canceled)
